(19) United States
(12) Patent Application Publication
(10) Pub. No.: US 2007/0013861 A1
(43) Pub. Date: Jan. 18, 2007

(54) Apparatus for and method of manufacturing liquid crystal display

(75) Inventor: Woo-jae Lee, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/487,236

(22) Filed: Jul. 14, 2006

(30) Foreign Application Priority Data
Jul. 14, 2005 (KR) 10-2005-0063617

(51) Int. Cl. G02F 1/13

(52) U.S. Cl. 349/187

(57) ABSTRACT

Disclosed is an apparatus for manufacturing a liquid crystal display, the apparatus including: a first support member for supporting a substrate and a transfer photosensitive film disposed on the substrate and a second support member disposed to face the first support member. An elastic member is provided on the surface of the second support member for allowing the transfer photosensitive film to be moved into contact with the substrate. A driving unit is provided for moving the first support member and the second support member toward and away from each other. A vacuum chamber is provided for receiving the first support member and the second support member.

This application claims priority to Korean Patent Application No. 2005-0063617, filed on Jul. 14, 2005, the contents of which are incorporated herein by reference in its entirety.

### BACKGROUND OF THE INVENTION

1. Field of the Invention

The present invention relates to an apparatus for and a method of manufacturing a liquid crystal display in general, and more particularly, to an apparatus for and a method of manufacturing a liquid crystal display by tightly adhering a transfer photosensitive film to a substrate to be used as a liquid crystal display panel.

2. Description of the Related Art

A liquid crystal display (“LCD”) includes a liquid crystal panel, a backlight unit and a driving unit. The liquid crystal panel includes a thin film transistor (“TFT”) substrate on which thin film transistors are formed, a color filter substrate on which color filters are provided, and liquid crystals injected between both substrates. For the insulating substrate, recently, plastic has been used instead of glass because it can be a thinner and more flexible substrate, which is desirable for a display for mobile applications, compared with the glass.

In manufacturing process of the thin film transistor substrate, gate electrodes, source/drain electrodes, active regions, inorganic layers, organic layers and pixel electrodes in desired patterns are formed. Further, in manufacturing process of a color filter substrate, black matrixes and color filters in desired patterns are formed. In order to form such desired patterns, a plurality of processes such as depositing a thin film, preparing a photoresist layer on the thin film, exposing and developing the photoresist layer and etching the thin film are performed repeatedly as desired.

The photoresist layer is typically prepared by coating liquid photoresist on a thin film to be patterned, which is provided on a substrate, and then evaporating a solvent contained in the liquid photoresist by a soft bake process. Alternatively, it is prepared by laminating a transfer photosensitive film onto a thin film to be patterned, which is provided on a substrate.

In the former method, the substrate coated with the liquid photoresist should be caused to undergo a soft bake process which is a thermal process to treat the liquid photoresist by heat at 120 degrees C, thereby evaporating the solvent and the like. Accordingly, this method is disadvantageous in that the insulating substrate made of plastic can be deformed during the soft bake process. In order to overcome such a problem, there is proposed a method in which the insulating substrate made of plastic is preheated before the photoresist layer is coated to avoid the thermal deformation during the soft bake process.

However, in the latter method, the insulating substrate made of plastic undergoes a high pressure in order to tightly adhere the transfer photosensitive film to the substrate. The substrate to be provided with the thin film to be patterned typically has a rough surface. Accordingly, if the transfer photosensitive film is not perfectly adhered to the substrate with application of a high pressure, air bubbles may be exist between the substrate and the transfer photosensitive film. Accordingly, in order to solve such a problem, the transfer photosensitive film includes a cushion layer on a photoresist layer. The cushion layer enables the photoresist layer to perfectly adhere to along the surface of the substrate by its resilient property, thereby reducing the number of air bubbles retained between the photoresist layer and the substrate after lamination of the photosensitive film. Accordingly, in order to reduce the number of air bubbles, the cushion layer should be resilient. The resilience of the cushion layer increases as the temperature is increased within a predetermined temperature range. Accordingly, suitable heat should be applied to the transfer photosensitive film to reduce the number of air bubbles.

However, such heat treatment is problematic because it can cause deformation to an insulating substrate made of plastic, and increase manufacturing cost.

### BRIEF SUMMARY OF THE INVENTION

Accordingly, it is an aspect of the prevent invention to provide an apparatus for manufacturing a liquid crystal display apparatus, capable of preventing thermal deformation of an insulating substrate made of plastic, lowering the manufacturing cost and enhancing the productivity, is provided.

Further, it is aspect of the present invention to provide a method of manufacturing a liquid crystal display, capable of preventing thermal deformation of a insulating substrate made of plastic, lowering the manufacturing cost and enhancing the productivity.

The foregoing and/or other aspects of the present invention are achieved by providing an apparatus for manufacturing a liquid crystal display, comprising: a first support member for supporting a substrate and a transfer photosensitive film disposed on the substrate; a second support member disposed to face the first support member; an elastic member provided on the surface of the second support member for allowing the transfer photosensitive film to close contact with the substrate; a driving part for making the first support member and the second support member get close to and away from each other; and a vacuum chamber for receiving the first support member and the second support member.

According to an exemplary embodiment of the present invention, the substrate includes an insulating substrate made of plastic.

According to an exemplary embodiment of the present invention, an apparatus for manufacturing a liquid crystal display further comprises a fluid injection member for injecting fluid into between the second supporting member and the elastic member to enable the elastic member to apply a pressure to the transfer photosensitive film, thereby bringing the transfer photosensitive film into close contact with the substrate, where edge portions of the elastic member are fixed to the vacuum chamber or the second support member.

According to an exemplary embodiment of the present invention, the elastic member is a rubber material.

According to an exemplary embodiment of the present invention, the fluid is air.

According to an exemplary embodiment of the present invention, the vacuum chamber includes: a first receiving part for receiving the first support member; and a second receiving part for receiving the second support member.

According to an exemplary embodiment of the present invention, an apparatus for manufacturing a liquid crystal display further comprises a heat generation part provided to at least one of the first support member and the second support member.

According to an exemplary embodiment of the present invention, the heat generation part is implemented by a hot wire.

According to an exemplary embodiment of the present invention, an apparatus for manufacturing a liquid crystal display further comprises a transferring unit for transferring at least one of the transfer photosensitive film and the substrate onto a receiving position of the first support member to be received on the receiving position.

According to an exemplary embodiment of the present invention, the transferring unit is a roller.

The foregoing and/or other aspects of the present invention are also achieved by providing a method of manufacturing a liquid crystal display, comprising the steps: (a) disposing a substrate and a transfer photosensitive film provided on the substrate on a first support member which faces a second support member; (b) removing air held between the substrate and the transfer photosensitive film; and (c) mutually pressing the first support member and the second support member to each other, thereby bringing the transfer photosensitive film into close contact with the substrate.

According to an exemplary embodiment of the present invention, the second support member is provided with an elastic member on the surface thereof that facing the first support member, thereby the elastic member applies a pressure to the transfer photosensitive film as fluid is injected between the second support member and the elastic member during the step (c).

According to an exemplary embodiment of the present invention, the transfer photosensitive film comprises: a photoresist layer; an oxygen permeation protection layer formed on the photoresist layer; a base layer formed on the oxygen permeation protection layer; and an electrostatic protection layer formed on the base layer.

According to an exemplary embodiment of the present invention, the step (a) comprises a step of transferring at least one of the substrate and the transfer photosensitive film onto a receiving position of the first support member.

According to an exemplary embodiment of the present invention, the step of transferring is performed by a roller.

According to an exemplary embodiment of the present invention, the first support member and the second support member are disposed in a vacuum chamber, and the removing air is performed to remove the air in the vacuum chamber in the status that the vacuum chamber is closed.

According to an exemplary embodiment of the present invention, the step (C) is performed in the status that at least one of the first support member and the second support member is heated.

### BRIEF DESCRIPTION OF THE DRAWINGS

FIG. 1 is a cross-sectional view of an apparatus for manufacturing a liquid crystal display according to a first embodiment of the present invention;

FIGS. 2A to 2C are cross-sectional views for explaining a method of manufacturing a liquid crystal display using the apparatus according to the first embodiment of the present invention;

FIG. 3 is a cross-sectional view of an apparatus for manufacturing a liquid crystal display, according to a second embodiment of the present invention; and

FIG. 4 is a cross-sectional view of an apparatus for manufacturing a liquid crystal display, according to a third embodiment of the present invention.

### DETAILED DESCRIPTION OF THE INVENTION

Reference is made below in detail to exemplary embodiments of the present invention, examples of which are illustrated in the accompanying drawings, wherein like reference numerals refer to like elements throughout and like elements explained with reference to a first embodiment once can be omitted in explanation with reference to different embodiments.

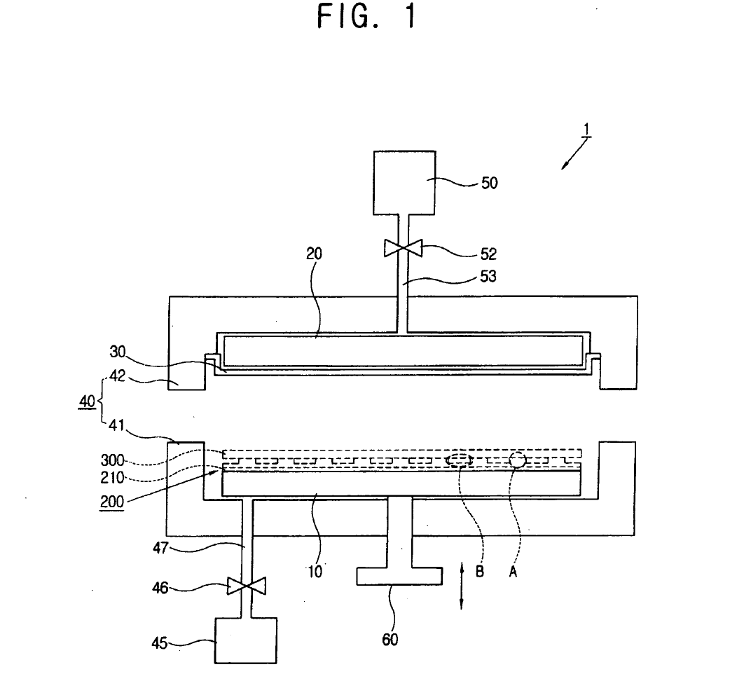

A first embodiment of a manufacturing apparatus for a liquid crystal display is described below with reference to FIG. 1. FIG. 1 is a cross-sectional view of an apparatus for manufacturing a liquid crystal display, in accordance with a first embodiment of the present invention.

Referring to FIG. 1, a liquid crystal display manufacturing apparatus 1 in accordance with the first embodiment of the present invention includes a first support member 10, a second support member 20, an elastic member 30, a driving part 60, a vacuum chamber 40 and a fluid injection member 50.

The first support member 10 supports a substrate 200 with stepped portions on the surface thereof and to be provided with a plurality of patterns and a transfer photosensitive film 300 disposed on the substrate 200 and adhered close to the substrate 200 by a means of pressing. The first support member 10 and the second support member 20 are mutually pressed toward each other so that the substrate 200 and the transfer photosensitive film 300 come into close contact with each other. The first support member 10 may be constructed of aluminum or other materials, having sufficient hardness to endure the pressure applied thereto and exhibit high thermal conductivity.

The substrate 200 may be a thin film transistor substrate or a color filter substrate used to manufacture a liquid crystal display panel. The substrate 200 includes an insulating substrate 210, and the insulating substrate 210 may be made of plastic which can be implemented into a thin and flexible substrate, but is not limited thereto. That is, the insulating substrate 210 also can be formed of glass. Suitable plastic materials include polycarbon, polyimide, Poly ethersulfones (PES), poly acrylate (PAR), polyethylenenaphthalate (PEN), and Polyethylenteleptalate (PET). The substrate 200 is provided with a thin film to be patterned on the surface thereof. The surface of the substrate 200 has the stepped portions since a plurality of patterns are formed thereon by a plurality of patterning process steps, that is the substrate 200 has convex portions (denoted by reference symbol “A”) and concave portions (denoted by reference symbol “B”) on the surface thereof.

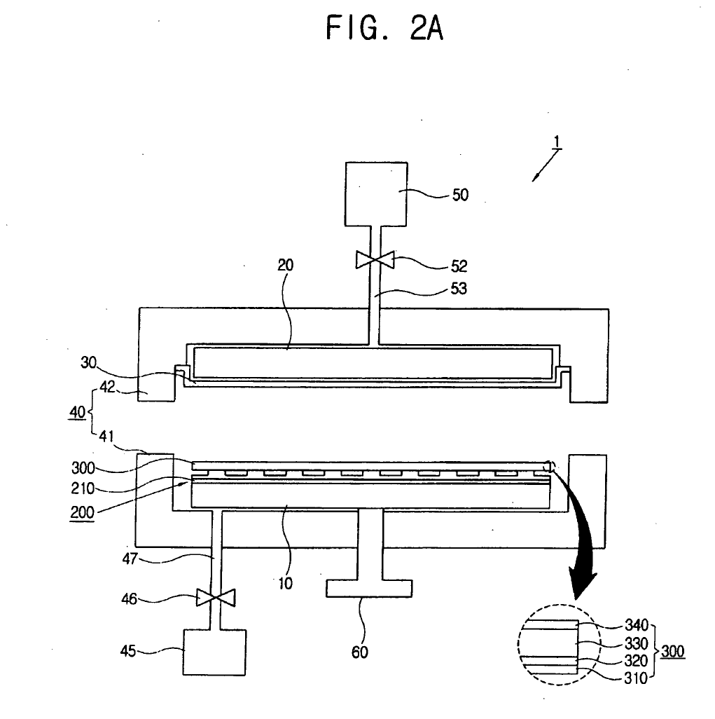

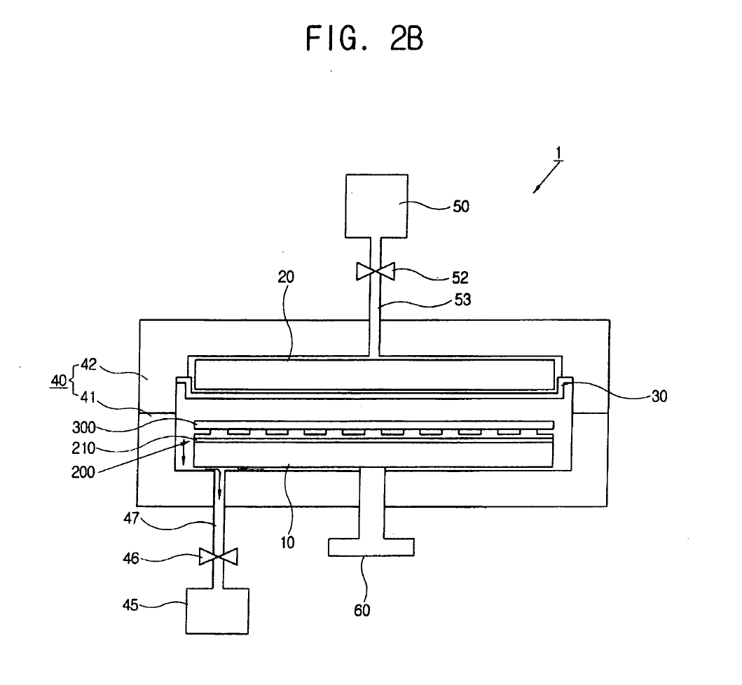

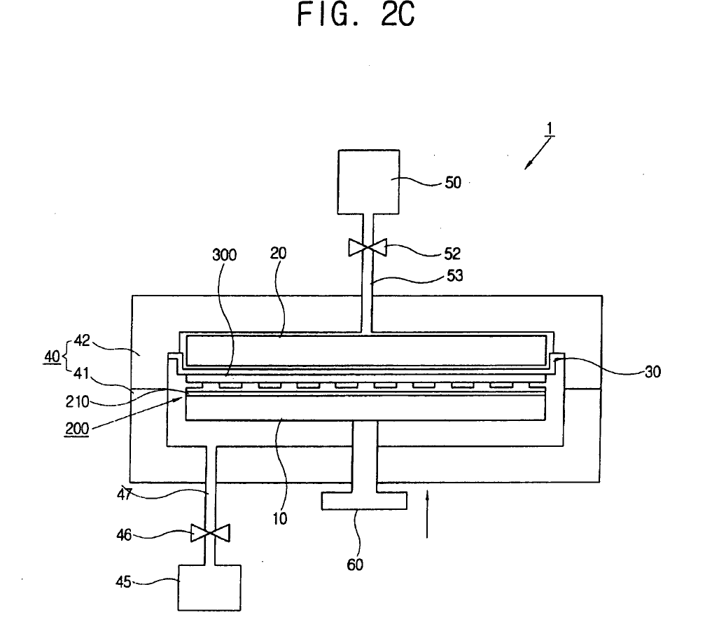

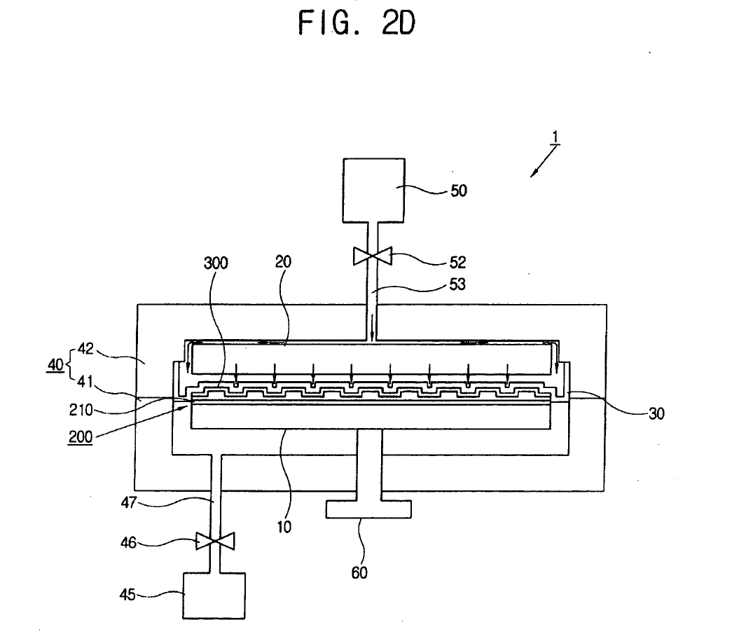

As shown in FIG. 2A, transfer photosensitive film 300 includes a base layer 330, an oxygen permeation protection layer 320, and a photoresist layer 310 sequentially stacked in order from the bottom. A cover layer (not shown) is provided on an upper part of the photoresist layer 310 once but removed before the photosensitive film is adhered onto the surface of the substrate 200. On the back surface of the base layer 330, an electrostatic protection layer 340 is provided. In a typical LCD manufacturing process, a cushion layer is formed between the oxygen permeation protection layer 320 and the base layer 330. However, the cushion layer is not necessary when the manufacturing apparatus in accordance with the first embodiment of the present invention is used. Accordingly, it is possible to reduce manufacturing cost of the LCD by using the manufacturing apparatus in accordance with the first embodiment of present invention. The reason is described below.

The base layer 330 serves as a framework to maintain the shape of the transfer photosensitive film 300, and is removed together with the electrostatic protection layer 340 after the photoresist layer 310 of the transfer photosensitive film 300 is glued to the substrate 200 and exposed to light.

The oxygen permeation protection layer 320 is disposed on an upper part of the base layer 330. The oxygen permeation protection layer 320 prevents oxygen form permeating into the photoresist layer 310 before the photoresist layer 310 is hardened by light exposure. The oxygen permeation protection layer 320 may be removed in a method of ashing together with the photoresist layer 310 after the light exposure and etching processes are performed.

The photoresist layer 310 is disposed on an upper part of the oxygen permeation protection layer 320. The photoresist layer 310 is a layer to be substantially glued to the surface of the substrate 200, and hardened during the light exposure process. The photoresist layer 310 is in solid state when it is disposed onto the substrate 200 because it undergoes to a thermal process such as a soft bake process to remove a solvent contained therein before it is applied onto the substrate 200.

The base layer 330 is provided with the electrostatic protection layer 340 on the back surface thereof. The electrostatic protection layer 340 protects the substrate 200 from static electricity caused during the removal process of the base layer 330 after completion of gluing the transfer photosensitive film 300 to the substrate 200.

The second support member 20 is disposed to face the first support member 10 such that the second support member 20 and the first support member 10 are mutually pressed to each other during the manufacturing process. The second support member 20 may also be formed of the identical material to the first support member 10, that is, it is formed of aluminum which has excellent thermal conductivity and sufficient hardness.

On the surface of the second support member 20, an elastic member 30 is disposed. The elastic member 30 transfers a pressure of the second support member 20 to the transfer photosensitive film 300 received on the first support member 10 when the first support member 10 and the second support member 20 are pressed to each other. The elastic member 30 is expandable, thereby playing a role to make the transfer photosensitive film 300 adhere closely to the stepped upper surface of the substrate 200, and it is formed of a rubber material with elasticity, thereby returning to its original shape when the pressure applied thereto is lifted. The edge of the elastic member 30 is fixed to a second receiving part 42 of a vacuum chamber 40.

The first support member 10 and the second support member 20 are received in the vacuum chamber 40. The vacuum chamber 40 includes a first receiving part 41 on which the first support member 10 is received and the second receiving part 42 on which the second support member 20 is received. When the first receiving part 41 and the second receiving part 42 are combined with each other, the vacuum chamber 40 is closed. A chamber driving part (not shown) is installed outside of the vacuum chamber 40 to move the first receiving part 41 and the second receiving part 42 get close to and away from each other.

A vacuum generation member 45 is installed on the outside of the vacuum chamber 40 and connected to the inside of the vacuum chamber 40 through a vacuum exhaust pipe 47. The vacuum generation member 45 purges the air in the vacuum chamber 40 after opening a vacuum valve 46. The vacuum generation member 45 may be a vacuum pump.

Further on the outside of the vacuum chamber 40, a driving part 60 is provided in a lower part of the first receiving part 41 such that it is connected to the first support member 10, penetrating the first receiving part 41. The driving part 60 moves the first receiving part 41 and the second receiving part 42 such that the first support member 10 disposed on the first receiving part 41 and the second support member 20 disposed on the second receiving part 42 come close to each other, thereby pressing the first support member 10 and the second support member 20 toward each other. That is, the first support member 10 and the second support member 20 are repeatedly shuttled to get close to and away from each other by the driving part 60. The driving part 60 may be installed at the corresponding position to the present position above the second receiving part 42, or installed on both sides of the first receiving part 41 and the second receiving part 42.

Still further on the outside of the vacuum chamber 40, a fluid injection member 50 is installed and connected to the inside of the vacuum chamber 40 through a fluid injection pipe 53. The fluid injection member 50 is provided to move the elastic member 30 toward the transfer photosensitive film 300 so that the transfer photosensitive film 300 perfectly adheres to the entire upper surface of the substrate 200. That is, if the fluid injection member 50 injects fluid between the second support member 20 and the elastic member 30, the elastic member 30 expands due to the injected fluid, so that the transfer photosensitive film 300 perfectly comes into close contact with the surface of the substrate 200, and particularly even comes into contact with the surface of concave portions (denoted by reference symbol “B”) on the substrate 200 with the stepped surface. Air can be used as the fluid due to its easy treatment.

Hereinafter, a method of manufacturing a liquid crystal display using the manufacturing apparatus 1 according the first embodiment of the present invention will be described with reference to FIG. 2A to FIG. 2D. FIGS. 2A to 2D are cross-sectional views to explain the method of the present invention.

In accordance with the method of the present invention, referring to FIG. 2A, the substrate 200 is provided on the first support member 10 and then the transfer photosensitive film 300 is disposed on substrate 200. In this step, the vacuum chamber 40 is opened, that is, the first receiving part 41 and the second receiving part 42 are separated. Accordingly, the work of loading the substrate 200 and the transfer photosensitive film 300 onto the first support member 10 on the first receiving part 41 is easy.

Referring to FIG. 2B, air between the substrate 200 and the transfer photosensitive film 300 is removed. In this step, a chamber driving part (not shown) moves the first receiving part 41 and the second receiving part 42 to get close to and then finally be combined with each other, thereby closing and sealing the vacuum chamber 40. After that, the air in the vacuum chamber 40 is exhausted by opening the vacuum valve 46 of the vacuum generation member 45 which is a vacuum pump, and starting the vacuum pump. In this step, air between the substrate 200 and the transfer photosensitive film 300, particularly in the concave portions (denoted by reference symbol “B”) of the substrate 200, is removed. By this step, it is possible to reduce the amount of air bubbles generated between the substrate 200 and the photoresist layer 310 of the photosensitive film 300. Accordingly, a cushion layer is not necessary in the method of present invention because air which would cause air bubbles is substantially completely removed in this step. Further, since a thermal process to remove air bubbles is not necessary, an insulating substrate 210 made of plastic is prevented from deforming. Accordingly, it is possible to reduce manufacturing cost and the percent of defective of liquid crystal displays and enhance manufacturing productivity by shortening the manufacturing process period.

As shown in FIG. 2C, the first support member 10 and the second support member 20 are pressed together, thereby moving photosensitive film 300 into close contact with substrate 200. In this step, the driving part 60 connected to the first support member 10 moves the first support member 10 to get close to the second support member 20 as shown in FIG. 2C. As a result, photosensitive film 300 is moved into close contact with the elastic member 30 on the second support member 20.

Next, referring to FIG. 2D, the fluid valve 52 of the fluid injection member 50 is opened and the fluid is injected between the second support member 20 and the elastic member 30 through the fluid injection pipe 53. In this embodiment, air is preferable fluid due to its easy treatment. As a result, elastic member 30 on the second support member 20 applies a pressure to the transfer photosensitive film 300 by elastic force of the elastic member 30 which expands due to the pressure of the fluid. The transfer photosensitive film 300 is accordingly moved to fit into the uneven surface of the substrate 200, particularly to the surface of concave portions (denoted by “B”) of the substrate 200, so that the transfer photosensitive film 300 more perfectly comes into close contact with the substrate 200 over the entire surface.

In this embodiment, the first support member 10 and the second support member 20 come close to each other before the fluid injection, but the method of this invention is not limited thereto. The fluid can be injected before the first support member 10 and the second support member 20 get close to each other, or may be injected while the first support member 10 and the second support member 20 are getting close to each other.

After the fluid pressure is removed by the fluid injection member 50 and the vacuum to the vacuum chamber 40 is removed, the substrate 200 with the transfer photosensitive film 300 tightly adhered to the surface of substrate 200 is taken out of vacuum chamber 40.

As described above, in accordance with the present invention, a cushion layer for photosensitive film 300 adhered to the substrate 200 is not necessary, and a thermal process to remove air bubbles can also be omitted in the manufacturing process of a liquid crystal display. Therefore, deformation of the insulating substrate 210 made of plastic is prevented, resulting in reduced manufacturing and increased productivity.

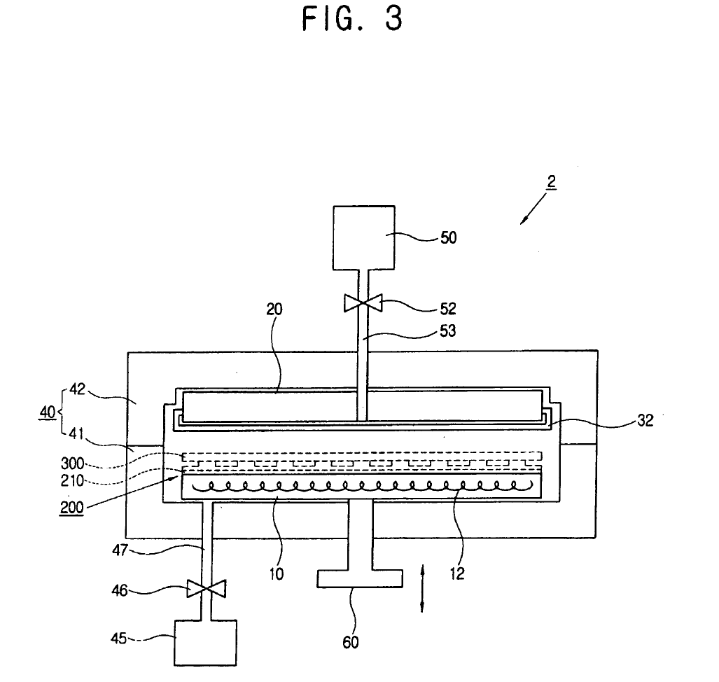

Below, a manufacturing apparatus for a liquid crystal display, in accordance with a second embodiment of the present invention is described. FIG. 3 is a cross-sectional view of the manufacturing apparatus according to the second embodiment of the present invention.

In the manufacturing apparatus 2 according to the second embodiment of the present invention, the elastic member 32 is fixed to the second support member in particular to a lateral side of the second support member 20 in contrast to the first embodiment in which elastic member 30 is fixed to the second receiving part 42 of the vacuum chamber 40. Accordingly, the fluid injection pipe 53 which is a passage of fluid to inject fluid between the second support member 20 and the elastic member 30 penetrates the second support member 20 and extends onto the second support member 20. The manufacturing apparatus 2 according to the second embodiment of the present invention has the identical advantages achieved by the manufacturing apparatus 1 according to the first embodiment of the present invention.

The manufacturing apparatus 2 according to the second embodiment of the present invention is further provided with a heat generation part, such as resistance wire 12 to which an electrical potential is applied on the inside of the first support member 10. Resistance wire 12 provides heat in an amount less than that which would result in deformation to the insulating substrate made of plastic, to the first support member 10, thereby enhancing adherence between the transfer photosensitive film 300 and the substrate 200. A resistance wire could alternatively be provided on the inside of the second support member 20, or it could be provided to both of the first support member 10 and the second support member 20.

As described above, the manufacturing apparatus 2 according to the second embodiment of the present invention is different in some elements, but the manufacturing method of a liquid crystal display using the manufacturing apparatus 2 according to the second embodiment is identical to the method using the manufacturing apparatus 1 according to the first embodiment. Accordingly, the method of manufacturing a liquid crystal display using the manufacturing apparatus 2 according to the second embodiment is not repeated.

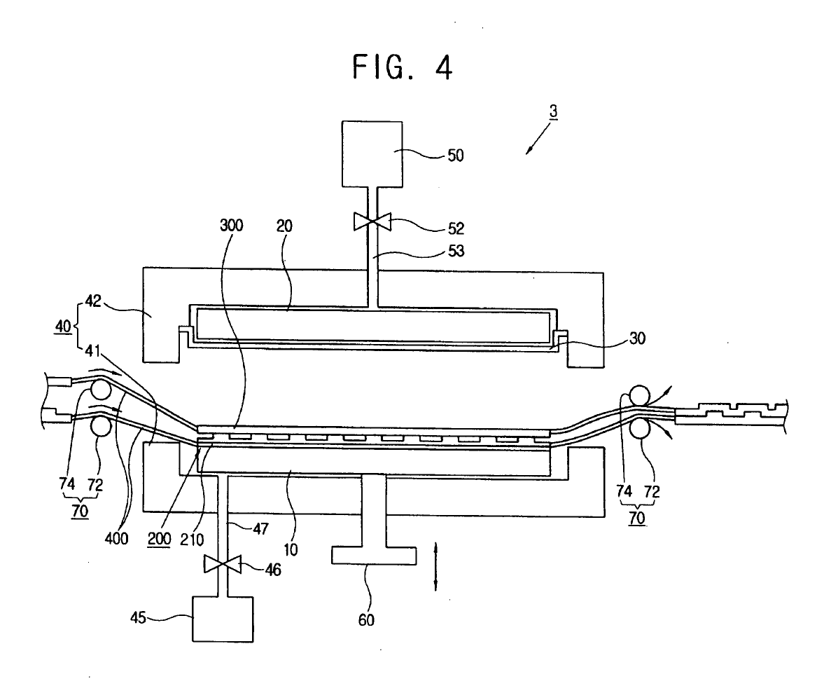

A manufacturing apparatus for a liquid crystal display, according to a third embodiment of the present invention, is described below with reference to FIG. 4. FIG. 4 is a cross-sectional view of a manufacturing apparatus for a liquid crystal display according to the third embodiment of the present invention.

Referring to FIG. 4, a manufacturing apparatus 3 according to the third embodiment of the present invention is additionally provided with a roller system 70 which includes rollers 72 and 74, to move the substrate 200 and the transfer photosensitive film 300, from the outside to the inside of vacuum chamber 40.

The lower roller 72 continuously moves the substrate 200 to dispose the substrate 200 on the receiving position of the first support member 10. The upper roller 74 continuously moves to transfer photosensitive film 300 to the corresponding position to the substrate 200 disposed on the first support member 10 such that the transfer photosensitive film 300 is disposed on the substrate 200. A plurality of substrates 200 are connected in series by a coupling member 400 so that the substrates 200 can be continuously moved to and disposed on the first support member 200. Further, a plurality of photosensitive films 300 are connected in series by the coupling member 400 so that they can be continuously moved to and adhered to the corresponding substrates 200. The coupling member 400 may be formed of a synthetic resin such as poly ethylene terephthalate (PET) film, which is thin but strong. The coupling member 400 is pressed between first receiving part 41 and the second receiving part 42 when the first receiving part 41 and the second receiving part 42 of the vacuum chamber 40 are combined. Because coupling member 400 is thin and flexible, it does not adversely affect vacuum chamber 40.

The manufacturing apparatus 3 according to the third embodiment of the present invention has the identical advantages of the manufacturing apparatii 1 and 2 according to the first and second embodiments of the present invention. Manufacturing apparatus 3 according to the third embodiment of the present invention has the additional advantage that the adhesion process of photosensitive films 300 to the substrates 200 can be continuously performed instead of being performed in a batch process. Accordingly, manufacturing productivity of liquid crystal displays is more enhanced.

As described above, the manufacturing apparatus 3 according to the third embodiment of the present invention is different in some elements from the manufacturing apparatus 1 and 2 according to the first and second embodiments of the present invention, but the manufacturing method of a liquid crystal display using the manufacturing apparatus 3 is identical to the methods using the manufacturing apparatus 1 and 2. Accordingly, further description of the method of manufacturing a liquid crystal display using the manufacturing apparatus 3 is not required.

As described above, the present invention provides an apparatus and a method of manufacturing a liquid crystal display, capable of reducing manufacturing cost, enhancing productivity, and preventing deformation of an insulating substrate made of plastic.

Although only three embodiments of the present invention have been shown and described, it will be appreciated by those skilled in the art that changes may be made in these embodiments without departing from the principles and spirit of the invention, the scope of which is defined in the appended claims and their equivalents. The use of the terms first and second, do not denote any order or importance, but rather the terms first and second are used to distinguish one element from another. Furthermore, the use of the terms a, an, and similar term do not denote a limitation of quantity, but rather denote the presence of at least one of the referenced item.

What is claimed is:

1. An apparatus for manufacturing a liquid crystal display, comprising:
a first support member for supporting a substrate and a transfer photosensitive film disposed on the substrate;
a second support member having a first surface facing the first support member;
an elastic member provided positioned adjacent the first surface of the second support member;
a driving mechanism for moving the first support member and the second support member toward and away from each other; and
a vacuum chamber for receiving the first support member and the second support member.

2. The apparatus according to claim 1, wherein the substrate includes an insulating substrate made of plastic.

3. The apparatus according to claim 1, further comprising a fluid injection structure for injecting fluid into between the second supporting member and the elastic member, wherein the elastic member is supported by the vacuum chamber or the second support member.

4. The apparatus according to claim 1, wherein the elastic member is comprised of rubber.

5. The apparatus according to claim 3, wherein the fluid is air.

6. The apparatus according to claim 1, wherein the vacuum chamber includes:
a first receiving part for receiving the first support member; and
a second receiving part for receiving the second support member.

7. The apparatus according to claim 1, further comprising a heat generating structure associated with at least one of the first support member and the second support member.

8. The apparatus according to claim 7, wherein the heat generating structure is comprised of a resistance heating element.

9. The apparatus according to claim 1, further comprising a transferring mechanism for transferring at least one of the transfer photosensitive film and the substrate onto a receiving position of the first support member.

10. The apparatus according to claim 9, wherein the transferring mechanism comprises a roller.

11. A method of manufacturing a liquid crystal display, comprising:
(a) disposing a substrate having a transfer photosensitive film on a surface of the substrate to a receiving position on a first support member;
(b) providing a second support member having a first surface facing the first support member; and
(c) moving the first support member and the second support member toward each other to press the transfer photosensitive film onto the substrate.

12. The method according to claim 11, further comprising:
(d) evacuating air between the substrate and the transfer photosensitive film.

13. The method according to claim 11, wherein the second support member further comprises an elastic member positioned adjacent the first surface of second support member, and further wherein in (c) fluid is injected between the second support member and the elastic member.

14. The method according to claim 11, wherein the transfer photosensitive film comprises:
a photoresist layer;
an oxygen permeation protection layer on the photoresist layer;
a base layer on the oxygen permeation protection layer; and
an electrostatic protection layer on the base layer.

15. The method according to claim 11, wherein (a) comprises transferring at least one of the substrate and the transfer photosensitive film onto the receiving position of the first support member.

16. The method according to claim 15, wherein the transferring comprises moving the substrate supported on a first web of material, the transfer photosensitive film supported on a second web of material, or both into the receiving position.

17. The method according to claim 12, wherein the first support member and the second support member are disposed in a vacuum chamber, and the evacuating of air is performed by applying a vacuum to the vacuum chamber.

18. The method according to claim 11, wherein heat is applied to at least one of the first support member and the second support member.

19. The method according to claim 18, wherein heat is applied using a resistance heating structure.
